(19) United States
(12) Patent Application Publication
(10) Pub. No.: US 2008/0161482 A1
(43) Pub. Date: Jul. 3, 2008

(54) Functional material powder, method for fabricating the same and functional staple fiber containing the same

(75) Inventor: Chih-Lien Ko, Taichung City (TW)

Correspondence Address: Joe McKinney Muncy, PO Box 1364, Fairfax, VA, 22038-1364, US

(73) Assignee: DIAMOND POLYMER SCIENCE CO., LTD

(21) Appl. No.: 11/647,293

(22) Filed: Dec. 29, 2006

(51) Int. Cl. B32B 27/00; C08J 3/20; C08L 77/00; C08L 31/06; C08L 33/20; C08L 75/04

(52) U.S. Cl. 524/556; 428/402; 523/351; 524/606; 524/559; 524/612

(57) ABSTRACT

The present invention discloses a functional material powder, a method for fabricating the same and a functional staple fiber containing the same. The functional material powder comprises particles with a diameter of 50˜350nm, 0.5˜1.5% of a dispersant, 3˜5% of a surfactant, and 1˜2% of a coupling agent. A small-capacity mill is used to fabricate the functional material powder of the present invention, wherein the small-capacity mill operates at a high power to generate a great impact force and a great shear force to fast nanomize the particles of the functional material. Further, in considering the future application, a surfactant and a coupling agent are added into the functional material powder to disperse the powder and promote the coupling strength between the particles and the molecules of a chemical fiber.

### FIELD OF THE INVENTION

The present invention relates to a nanometric functional material powder, a method for fabricating the same and a functional staple fiber containing the same.

### BACKGROUND OF THE INVENTION

Recently, an interesting topic is prevailing: activating cells with the so-called active ions to improve health. Many researches focus on regulating the autonomic nervous system and the motor nervous system with active ions to aid deep sleep, promote nervous stability and accelerate refreshment.

Tourmaline is one of the functional materials which can release the so-called active ions. Tourmaline may be a natural mineral or an artificial product. Tourmaline is a cyclosilicate containing Al, Na, Fe, Mg, Li and especially B. Among electret minerals, tourmaline has the highest permanent spontaneous polarizability, and the polarizability vector thereof is not affected by external electric field. According to recent reports, the far-infrared ray radiated by tourmaline can improve water quality, aid food preservation, upgrade food quality, accelerate plant growth, promote blood circulation and enhance metabolism.

Therefore, integrating daily use products with far-infrared-radiating functional materials usually generates surprising effects. For example, adding the functional materials into a textile not only can create a heat-preserving and warm-keeping effect but also can make the textile resonate with the 4˜20 μm wavelength emitted by the human body, and the healthcare efficacies, such activating cytoplasma and enhancing blood circulation, are thus attained.

A multi-functional textile contains a plurality of functional materials and combines the special functions of the functional materials. Many textile products are paraded as containing functional material powders. However, a 1 μm-diameter fine fiber needs the functional material particles with a diameter of less than 0.35 μm lest the fine fiber be fractured and the nozzle be choked. The nanometric functional materials needed by multi-functional textiles are still being developed by the related industries in many countries.

In the conventional technology, the particle size of a functional material powder can only be reduced to about 1.5 μm. Firstly, a functional material, such as tourmaline, is crushed by a crusher into grains having a diameter of about 15 μm. Next, 100∞250 kg of the functional material is mixed with 500˜800 kg of water, and the mixture is ground for 2.5 hours in a 50˜80 L mill with a power of 30˜50 KW to obtain a functional material powder having particles with a diameter of about 1.5˜3 μm, wherein the mixture also contains 50 kg of a grinding medium (such as zirconium oxide beads) with a diameter of 1.2˜1.6 mm and 80 kg of a grinding medium with a diameter of 1.6˜1.8 mm. Next, the abovementioned powder is ground in a second-stage grinding process for 2.5 hours to obtain a powder having a particle size distribution of D50/1.5 μm, wherein the abovementioned grinding mediums are replaced with 100 kg of a grinding medium with the diameter of 0.8˜1.2 mm, and an appropriate amount (about 0.5%) of dispersant (A9400) is added into the mixture, and D50/1.5 μm means that over 50% of particles have a diameter of less than 1.5 μm. In the conventional large-capacity grinding process, the impact force of the grinding media is hard to concentrate, and the shear force is thus unlikely to bring into full play. Therefore, the conventional technology can never achieve a particle diameter of less than 0.8 μm but can only obtain particles with a diameter of about 0.8˜3 μm.

In the conventional technology, a functional material powder will have high surface energy after a long time of grinding, and the particles are apt to aggregate for decreasing surface energy, and particle diameter reduction is thus slowed down with the increasing grinding time. The particle size can only be reduced to D50/1 μm˜D100/2 μm, wherein D100/2 μm means that 100% of particles have a diameter of less than 2 μm, and it is impossible to attain a further small particle size. No matter how the size and amount of the grinding media or the concentration of the functional material powder are varied, the particle size is unlikely to reduce to under D100/0.35 μm—the condition that a functional material powder can be added into a chemical fiber fabric.

In the conventional technology, a dispersant is used to improve the non-uniform distribution of particle size. Tourmaline is a highly crystalline solid with a density of 4 g/cm³ and with a hardness as high as 7.5 in the Mho's hardness scale. In the grinding process, the functional material powder is apt to agglomerate with the increasing grinding time and the increasing surface energy. However, the dispersant cannot prevent the powder from a secondary aggregation. Thus, once one of the critical grinding conditions is not satisfied, the particles cannot attain the size distribution of under D100/0.35 μm—the condition that a functional material powder can be added into a chemical fiber fabric.

The conventional functional material powders can provide additional functions for a chemical fiber. However, the conventional functional material powders are hard to physically combine with the polymeric molecules of a chemical fiber. When a chemical fiber contains over 3% of the conventional functional material powders, the chemical fiber becomes very fragile and apt to fracture.

### SUMMARY OF THE INVENTION

The primary objective of the present invention is to disclose a method to fast nanomize a functional material powder.

Another objective of the present invention is provide a functional material powder, wherein during nanomizing the functional material, a surfactant and a coupling agent are added into the functional material powder to provide a dispersing effect and a property-enhancing effect for the functional material powder; the functional material powder can thus be fast dispersed without a secondary aggregation in the future application, and the integration between the functional material powder and the molecules of a chemical fiber is thus enhanced.

The present invention proposes a functional material powder, which has particles with a diameter of 50˜350 nm, 0.5˜1.5% of a dispersant, 3˜5% of a surfactant and 1˜2% of a coupling agent, wherein the sum of the proportions of the dispersant, the surfactant and the coupling agent amounts to 6˜8%. Via the dispersant, the surfactant and the coupling agent, which can also function as an emollient and a setting agent, the functional material powder can be squeezed into masterbatch pellets with a diameter of about 2 mm for the succeeding fabrication.

The present invention also proposes a method for fabricating the abovementioned functional material powder, which comprises the following steps:

a. mixing 25˜30 kg of a composite functional material, 50˜75 kg of a treatment liquid and 0.5˜1% of a dispersant into a slurry, adding 42 kg of a grinding medium with a diameter of 2 mm into the slurry, and grinding the slurry into a powder having particles with an average diameter of 1˜1.51 μm with a 10 L-capacity mill for 20˜35 minutes at a power of 35˜40 KW, wherein the functional material may be tourmaline, alumina, zirconium oxide, magnesium oxide, titanium dioxide, zinc oxide, Maifan stone, or the combination of the abovementioned materials; the dispersant may be polyethylene glycol, polypropylene glycol, nonyl phenol or a natural alcohol; and the treatment liquid may be water, methanol or ethyl alcohol;

b. replacing the abovementioned grinding medium with a grinding medium having a diameter of 0.3˜0.6 mm, adding 0.5% of a dispersant into the powder, and performing a second-stage grinding for 35˜50 minutes to reduce the particle size of the functional material powder to 50˜350 nm;

c. adding 3˜5% of a surfactant into the product of the preceding step, wherein the surfactant is 13-docosenamide (13Z-C₂₂H₄₃NO) which is used to modify the surface of the particles to disperse the powder and prevent the powder from a secondary aggregation;

d. adding 1˜2% of a coupling agent into the product of the preceding step, wherein according to the chemical fiber to be used in the succeeding fabrication, the coupling agent may be a silane coupling agent or a titanate coupling agent; the coupling agent is used to modify the surface of the particles to disperse the powder and promote the coupling strength between the particles and the molecules of the chemical fiber; and

e. removing the treatment liquid with a dry vacuum distillation method to form a gel-like functional material powder.

Further, the abovementioned nanometric functional material powder may be added into a chemical fiber resin by a proportion as high as 6˜12% to form a textile material which is to be fabricated into a functional staple fiber. The functional material powder can be combined with a chemical fiber resin to form masterbatch pellets of a functional chemical fiber resin, and the masterbatch pellets are used as the raw material for fiber spinning. The chemical fiber resin and the functional material powder are mixed and then melted under the heat condition, and the molten chemical fiber resin is then squeezed and spun into a functional staple fiber. Alternatively, the functional material powder may be firstly compressed into masterbatch pellets having a diameter of 2 mm, and then is mixed with the functional material powder and then melted under the heat condition. The chemical fiber resin may be selected from the group consisting of PA (polyamide), PET (polyethylene terephthalate), PAN (polyacrylonitrile), and PU (polyurethane). Alternatively, the chemical fiber resin may also be a combination of the abovementioned chemical fiber resins.

Besides, the functional material powder may be squeezed with a high pressure to form masterbatch pellets with a diameter of 2 mm, and the functional material powder in the form of masterbatch pellets is thus easily mixed with the grains of a chemical fiber resin in the succeeding fabrication.

### DETAILED DESCRIPTION OF THE PREFERRED EMBODIMENTS

The technical contents of the present invention are to be described in detail below.

The present invention pertains to a functional material powder, which comprises particles with a diameter of 50˜350 nm, 0.5˜1.5% of a dispersant, 3˜5% of a surfactant, and 1˜2% of a coupling agent, wherein the functional material may be tourmaline, alumina, zirconium oxide, magnesium oxide, titanium dioxide, zinc oxide, Maifan stone, or the combination of the abovementioned materials; the dispersant may be PEG (polyethylene glycol), PPG (polypropylene glycol), NP (nonyl phenol) or a natural alcohol.

The present invention also proposes a method for fabricating the abovementioned functional material powder, which comprises the following steps:

a. mixing 25˜30 kg of a composite functional material, 50˜75 kg of a treatment liquid and 0.5˜1% of a dispersant into a slurry, adding 42 kg of a grinding medium with a diameter of 2 mm into the slurry, and grinding the slurry into a powder having particles with an average diameter of 1˜1.5 μm with a 10 L-capacity mill for 20˜35 minutes at a power of 35˜40 KW, wherein the treatment liquid may be water, methanol or ethyl alcohol, and wherein in comparison with the conventional mill, the present invention adopts a small and high-speed mill, which has a capacity of 10 L and operates at a power of 35˜40 KW and generates a high impact force and a great shear force five times the output of a conventional machine, to fast reduce the particle size to the micron scale for the succeeding nanometric grinding process;

b. replacing the abovementioned grinding medium with a grinding medium having a diameter of 0.3˜0.6 mm, adding 0.5% of a dispersant into the powder, and performing a second-stage grinding for 35˜50 minutes to reduce the particle size of the functional material powder to 50˜350 nm, wherein the dispersant is used to prevent the powder from the agglomeration resulting from the tendency of reducing surface energy; and the 0.3 mm-diameter grinding medium is used to nanomize the particles of the functional material powder to less than 350 nm;

c. adding 3˜5% of a surfactant into the product of the preceding step, wherein the surfactant is 13-docosenamide (13Z-C₂₂H₄₃NO) which is used to modify the surface of the particles to disperse the powder and prevent the powder from a secondary aggregation and make the functional material powder uniformly distributed in a molten chemical fiber resin;

d. adding 1˜2% of a coupling agent into the product of the preceding step, wherein according to the chemical fiber to be used in the succeeding fabrication, the coupling agent may be a silane coupling agent or a titanate coupling agent; the coupling agent is used to modify the surface of the particles to disperse the functional material powder and promote the coupling strength between the particles of the functional material powder and the molecules of a chemical fiber; and

e. removing the treatment liquid with a dry vacuum distillation method to form a gel-like functional material powder.

The functional material powder of the present invention has particles with a diameter of 50˜350 nm, 0.5˜1.5% of a dispersant, 3˜5% of a surfactant and 1˜2% of a coupling agent, wherein the sum of the proportions of the dispersant, the surfactant and the coupling agent amounts to 6˜8%. Via the dispersant, the surfactant and the coupling agent, which can also function as an emollient and a setting agent, the functional material powder can be squeezed into masterbatch pellets having a diameter of about 2 mm, and the functional material powder in the form of masterbatch pellets is thus easily mixed with the grains of a chemical fiber resin in the succeeding fabrication.

A multi-functional textile contains a plurality of functional materials, and the special functions of the functional materials are integrated into the same textile. To achieve the abovementioned objective, the following conditions should be satisfied: 1. the powders of the functional materials must be nanomized; 2. the powders of the functional materials must be activated to prevent the powder from a secondary aggregation and make the powder fast dispersed during application and; 3. the powders of the functional materials must be well coupled to the molecules of a chemical fiber. The functional material powders meeting the abovementioned three conditions will be mixed with the grains of a chemical fiber resin, and the mixture will be melted, squeezed and then spun into a functional staple fiber. The functional staple fiber can be blended with other staple fibers to spin them into a multi-functional textile. A well multi-functional textile should meet the following three conditions:

1. The powder of a functional material should be nanomized. The particle size of the functional material powder should be below 350 nm for a 1 μm-diameter fine fiber lest the dimension of the particle be over a third of the diameter of the fine fiber. If the dimension of the particle exceeds a third of the diameter of the fine fiber, the fine fiber is apt to fracture, and the nozzle is likely to choke. However, the hardness of a functional material, such as tourmaline, reaches 7.5 in the Mho's hardness scale, and the conventional grinding technology is unlikely to obtain a particle size of below 350 nm. In comparison with the conventional mill, the present invention adopts a high impact force and a great shear force, which are five times the output of a conventional machine, to reduce the particle size to the micron scale within 20˜35 minutes. Then, a nanometric grinding process follows, and a 0.3 mm-diameter grinding medium replaces the grinding media used in the preceding step, and a dispersant is added into the mixture to prevent the particles from the agglomeration resulting from the tendency of reducing surface energy, and the particle size is thus fast nanomized to below 350 nm.

2. A surfactant, which is diluted in a hot methanol, is added into the mixture to modify and activate surface of the particles of the functional material powder to prevent the particles from a secondary aggregation and make the functional material powder dispersed fast in the future application.

3. The particles of the functional material powder should be well coupled with the molecules of the chemical fiber to guarantee the mechanical strength of the particle-containing chemical fiber. The present invention utilizes a coupling agent to modify the surface of the particles, and the surface of the particles thus has OH functional groups to couple with the molecules of the chemical fiber. Therefore, the particles of the functional material powder can be well coupled with the molecules of the chemical fiber, and the chemical fiber containing the particles has a sufficient mechanical strength.

Via the activation of the surfactant and the modification of the coupling agent, the functional material powder of the present invention can be added into the raw material of the chemical fiber by a proportion as high as 6˜12%. The mixture is melted, fast squeezed and high-pressure spun into a functional staple fiber. The functional staple fiber can be blended with other staple fibers to fabricate a multi-functional textile, and the objective of integrating multiple healthcare functions into an identical textile is thus achieved.

The nanometric gel-like functional material powder of the present invention can be compounded with a chemical fiber resin to form a textile material, which is to be fabricated into a functional staple fiber. It should be mentioned specially that the functional material powder of the present invention can be added into a chemical fiber resin by a proportion as high as 6˜12%. During the polymerization of a chemical fiber resin, the functional material powder of the present invention may be added into the chemical fiber resin to form a slurry of a functional chemical fiber resin, and the slurry is then fabricated into masterbatch pellets of the functional chemical fiber resin, and the masterbatch pellets are to be used as a fiber-spinning material. The functional material powder of the present invention can also be added into the molten chemical fiber resin, and the molten chemical fiber resin is then squeezed and spun into a functional staple fiber. Further, the functional material powder of the present invention may be firstly compressed into masterbatch pellets with a diameter of 2 mm, and the functional material powder in the form of masterbatch pellets is thus easily mixed with the molten chemical fiber resin. The chemical fiber resin may be selected from the group consisting of PA (polyamide), PET (polyethylene terephthalate), PAN (polyacrylonitrile), and PU (polyurethane). The chemical fiber resin may also be the combination of the abovementioned chemical fiber resins. As the functional staple fiber of the present invention contains 6˜12% of the functional material powder of the present invention; therefore, the textile made of the functional staple fiber of the present invention can present more healthcare effect than the conventional functional staple fiber containing only 2˜3% of a functional material.

Besides, the functional material powder may be squeezed to form masterbatch pellets with a diameter of 2 mm, and the functional material powder in the form of masterbatch pellets is thus easily mixed with the grains of a chemical fiber resin in the succeeding fabrication.

Those described above are the preferred embodiments to exemplify the present invention. However, it is not intended to limit the scope of the present invention. Any equivalent modification or variation according to the spirit of the present invention is to be also included within the scope of the present invention.

What is claimed is:

1. A functional material powder, comprising:
a gel-like functional material powder having particles with a diameter of 50˜350 nm;
0.5˜1.5% of a dispersant;
3˜5% of a surfactant used to modify the surface of said particles of said functional material powder to improve the dispersion of said particles and prevent said particles from a secondary aggregation; and
1˜2% of a coupling agent used to modify the surface of said particles of said functional material powder to improve the dispersion of said particles and promote the coupling strength between said particles and the molecules of a chemical fiber resin.

2. The functional material powder according to claim 1, wherein said functional material is selected from a group consisting of tourmaline, alumina, zirconium oxide, magnesium oxide, titanium dioxide, zinc oxide, Maifan stone, and the combination of the abovementioned materials.

3. The functional material powder according to claim 1, wherein said dispersant is selected from a group consisting of polyethylene glycol, polypropylene glycol, nonyl phenol, and a natural alcohol.

4. The functional material powder according to claim 1, wherein said surfactant is 13-Docosenamide (13Z-C₂₂H₄₃NO).

5. The functional material powder according to claim 1, wherein according to the chemical fiber to be used in the succeeding fabrication, said coupling agent is a silane coupling agent or a titanate coupling agent.

6. A method for fabricating the functional material powder of claim 1, comprising the following steps:
a. mixing 25˜30 kg of a functional material, 50˜75 kg of a treatment liquid and 0.5˜1% of a dispersant into a slurry, adding 42 kg of a grinding medium with a diameter of 2 mm into said slurry, and utilizing a 10 L-capacity mill to grind said slurry for 20˜35 minutes at a power of 35˜40 KW to reduce said functional material into a powder having an average particle size of 1.5 μm;
b. replacing the abovementioned grinding medium with a grinding medium having a diameter of 0.3˜0.6 mm, adding 0.5% of a dispersant into the product of the preceding step, and performing a second-stage grinding for 35˜50 minutes to reduce the particle size of said powder to 50˜350 nm;
c. adding 3˜5% of a surfactant into the product of the preceding step to modify the surface of said particles to prevent said powder from a secondary aggregation;
d. adding 1˜2% of a coupling agent into the product of the preceding step to modify the surface of said particles to improve the dispersion of said powder and promote the coupling strength between said particles and the molecules of a chemical fiber resin; and
e. removing said treatment liquid with a dry vacuum distillation method to form a gel-like functional material powder.

7. The method for fabricating a functional material powder according to claim 6, wherein said treatment liquid is water, methanol or ethyl alcohol.

8. The method for fabricating a functional material powder according to claim 6, wherein said functional material is selected from a group consisting of tourmaline, alumina, zirconium oxide, magnesium oxide, titanium dioxide, zinc oxide, Maifan stone, and the combination of the abovementioned materials.

9. The method for fabricating a functional material powder according to claim 6, wherein said dispersant is selected from a group consisting of polyethylene glycol, polypropylene glycol, nonyl phenol, and a natural alcohol.

10. The method for fabricating a functional material powder according to claim 6, wherein said surfactant is 13-Docosenamide (13Z-C₂₂H₄₃NO).

11. The method for fabricating a functional material powder according to claim 6, wherein according to the chemical fiber to be used in the succeeding fabrication, said coupling agent is a silane coupling agent or a titanate coupling agent.

12. A functional staple fiber containing a functional material, which is fabricated from a mixture comprising the functional material powder of claim 1 and a chemical fiber resin, wherein the proportion of said functional material powder in said mixture is 6˜12%.

13. The functional staple fiber containing a functional material according to claim 12, wherein during the polymerization of said chemical fiber resin, said functional material powder is added into said chemical fiber resin to form a slurry of a functional chemical fiber resin, and said slurry is fabricated into masterbatch pellets of said functional chemical fiber resin, and said masterbatch pellets are to be used as a fiber-spinning material.

14. The functional staple fiber containing a functional material according to claim 12, wherein said chemical fiber resin and said functional material powder are mixed and then melted under the heat condition, and said chemical fiber resin is squeezed and spun into said functional staple fiber containing said functional material powder.

15. The functional staple fiber containing a functional material according to claim 14, wherein said functional material powder is beforehand squeezed to form masterbatch pellets with a diameter of 2 mm, and is mixed with functional material powder and then melted under the heat condition such that said functional material powder is thus easily mixed with said chemical fiber resin.

16. The functional staple fiber containing a functional material according to claim 12, wherein said chemical fiber resin is selected from a group consisting of PA (polyamide), PET (polyethylene terephthalate), PAN (polyacrylonitrile), and PU (polyurethane), and said chemical fiber resin may also be the combination of the abovementioned chemical fiber resins.
